(19) United States
(12) Patent Application Publication
(10) Pub. No.: US 2008/0022348 A1
(43) Pub. Date: Jan. 24, 2008

(54) Interactive video display system and a method thereof

(75) Inventor: Liyu Shen, Santa Ana, CA (US)

Correspondence Address: SINORICA, LLC, 528 FALLSGROVE DRIVE, ROCKVILLE, MD, 20850, US

(73) Assignee: Samoa Opulence Investment Inc.

(21) Appl. No.: 11/593,761

(22) Filed: Nov. 7, 2006

(30) Foreign Application Priority Data
Jul. 3, 2006 (TW) 095124213
Aug. 25, 2006 (TW) 095131493

(51) Int. Cl. H04N 7/16; G06F 3/00; H04N 5/445; G06F 13/00

(52) U.S. Cl. 725/135; 725/37; 725/38

(57) ABSTRACT

The present invention provides an interactive video display system and a method thereof for displaying video clips with a plurality of marks thereon. The present invention utilizes the sound, movements of a moving object, various movement directions or acting signals generated from a computer to produce a plurality of acting signals for controlling the display of the video clips incorporated with the sound effect to increase the reality of the image display. Marks are provided on the vide clip to indicates the movements or the exercising frequencies or the directions of the movements. The present invention provides a method and a system that can directly interact the user with the visual images in the video screen.

### FIELD OF THE INVENTION

The present invention relates to an interactive video display system and a method thereof, more particularly, to a system and a method which can provide a changing visual image and various aspects of the video display system are controlled by the user.

### BACKGROUND OF THE INVENTION

The conventional method of interacting between the user and the video display system is to receive the input signals from users, and through a complicated calculation of the trajectory, the light and the space, the animation is then produced, as a result, the user can control the functions of the motion display. The benefit of having the ability to control the animation is that the movement frequency, the movement direction and the movement intensity of the user can all be properly controlled and presented. On the contrary, the video display image is difficult to control and achieve a perfect state, and the reality image provided by the video is impossible to be replaced by the animation skill, and the needs of expensive computer equipments and software for producing the animation is another shortcoming.

U.S. Pat. No. 6,428,449 discloses an interactive system according to the user's movement and acoustic orders, wherein the disclosed system utilizes the combinations of the repeated body movement and the acoustic orders to control the changes of the display image, the repeated body movement controls the rhythm of the display motion and the acoustic orders command a plurality of virtual movements. Therefore, a user can create a lot of sets of virtual motions such as, shooting, swimming, standing, turning, sliding, walking and running etc., each movement is determined by the acoustic orders and the rhythm of the display motion is according to the repeated body movement of the user. Although, the acoustic orders can control simple movement such as, fetch something or deliver a particular good to a certain place. The disclosed method in U.S. Pat. No. 6,428,449 can only be used to command various behaviors in a virtual world, further, according to current technology, the virtual conditions created by the computer software are incomparable to the real video scenes. Moreover, those computer software are extremely expensive, a high-tech hard drive is required to incorporate with such software, the cost of the whole set of game is normally unaffordable to the general public.

U.S. Pat. No. 6,750,865 discloses a video simulating device in which it records a plurality of the video clips in various circumstantial conditions, then the video clips are computerized according to various parameters which are inputted by a user to determine which video clips should be played. For example, filming the fishing video clips in different seasons at different spots, then through the inputted parameters to analyze and determine which scenes of the video clips should be played. Although the video device disclosed in U.S. Pat. No. 6,750,865 can be applied in a game, the video clip can be chosen at different stages for the interaction between the user and the game, the prior art is limited to the conventional video game because the user can not control the video clips fully, he or she can only observe the game but not to command it. Therefore, the disclosed video simulating device provides restricted interactive functions between the user and the game.

Consequently, it is an objective of the present invention to provide an interactive video display system and a method in which a changing visual image and various aspects of the video display system are controlled by the user.

### SUMMARY OF THE INVENTION

Therefore, the objective of the present invention is to overcome and resolve the above-mentioned problems, including the current technical problems in the prior art.

It is an object of the present invention to provide an interactive video display system that can directly interact the user with the video simulating images.

It is another object of the present invention to provide various functions such as running motion, jumping motion in the video displaying system that is corresponding the movements of the user.

The interactive video displaying system in accordance with a preferred example of the present invention comprises a video displaying device for displaying video data, a data storage device having at least one video clip comprising a plurality of marks, wherein two of the marks are arranged respectively at a beginning part and an ending part of the video clip. The system further comprises an acting signal producing unit for producing and transmitting an acting signal, and a control device for setting a mark pointer on one of the marks of the video clip according to the acting signal produced by the acting signal producing unit, wherein a position of the mark pointer on the mark of the video clip is utilized as a display starting point to display the video data of the video clip in respect to the mark pointer.

The interactive video displaying system also comprises an audio player and an audio data producing unit, wherein the audio data producing unit produces an audio signal and transmits it to the audio player for display. At least one audio signal is recorded and stored in the data storage device, and the control device retrieves at least one audio signal that is prerecorded and stored in the data storage device in order to replace the audio data producing unit. An external electric device can be used as the audio data producing unit.

The acting signal producing unit further comprises a detecting device for detecting any variation of a movement direction of a moving object, when the detecting device detects the movement of the moving object, a starting point of movement and a turning point of a changing movement direction of the moving object, an acting signal is produced. The detecting device can comprise a functional key, when the functional key is triggered, the mark pointer will be moved to a next mark of the video clip immediately.

The acting signal producing unit utilizes a microphone to receive an audio signal and transfers this audio signal into an acting signal. The acting signal producing unit in such case can be an external electric device displays the audio signal, and transfers the audio signal into an acting signal.

It is another object of the present invention to provide an interactive video displaying method in accordance with another preferred example, comprising:

(a) producing a video clip with a plurality of marks; (b) setting a mark pointer on one of the marks located on the video clip; (c) receiving an acting signal in order to perform the next step; (d) moving the mark pointer from a current position towards an ending part of the video clip, and transferring corresponding video data of the video clip to a video displaying device in respect to the position of the mark pointer during the moving process. When the mark pointer is moved through a first quantity of marks or to the ending part of the video clip, then the mark pointer will be stopped, and the step (c) will be repeated, wherein when the acting signal is received during the proceeding of the step (d), the mark pointer will be moved to the next mark and the step (d) will be repeated.

The method further comprises of producing an audio data when the mark pointer reaches one of the marks, and transferring the audio data to an audio player for display. The method also includes to relocate the mark pointer at a beginning part of the video clip when the mark pointer arrives the ending part of the video clip, and the method then continues to proceed.

A detecting unit is provided onto the body or arms or legs of a user, when the user starts to move, the detecting unit detects the movement of the user and the changing points of indicating changes in movement direction in order to produce acing signals, and when the mark pointer moves from one mark to another mark, the audio data stored in the data storage device will be displayed.

It is another object of the present invention to provide an interactive video displaying method in accordance with another preferred example, comprising:

(a) producing a video clip with a plurality of marks thereon; (b) locating a mark pointer on one of the marks positioned on the video clip, setting a counter, and repeating a following step; (c) calculating a second quantity according to the value stored in the counter, retrieving a predetermined time unit, and proceeding the following steps within the predetermined time unit:
(c1) moving the mark pointer towards an ending part of the video clip from a present position, and arriving at a mark that is located right after passing through the second quantity of marks, wherein the video data of the video clip corresponding to the mark pointer is transmitted fast-forwardly, or slowly or normally to a video displaying device for displaying in such that the display can be performed exactly within the predetermined time unit; and
(c2) receiving a first quantity of acting signals, and saving the data of such first quantity in the counter.
The step (c) further comprises of producing an audio data and transferring it to an audio player for displaying when the mark pointer arrives one of the marks and the step (b) further comprises of setting a zero value in the counter. The mark pointer is relocated at a beginning part of the video clip when the mark pointer reaches the ending part of the video clip and the method continues to proceed.
According to another preferred example of the present invention, an interactive video displaying method comprises of:
   (a) producing a video clip with a plurality of video segments, wherein each video segment comprises a plurality of marks and is corresponding to different moving frequency, and the video segments have the same video time; (b) setting a counter and executing the next step repeatedly; (c) calculating a second quantity according to the data stored in the counter; selecting the video segment with corresponding moving frequency in accordance with the second quantity; retrieving a predetermined time unit that is equal to the video time of each video segment, and proceeding the following steps within the same predetermined time unit:
      (c1) retrieving the video data of the video segment and displaying it with normal speed; and
      (c2) receiving a first quantity of acting signals, and saving the data of such first quantity in the counter.
The step (c) further comprises of producing an audio data and transferring it to an audio player for displaying when the mark pointer arrives one of the marks, and setting a zero value in the counter.

The present invention further provides an interactive video displaying method, according to another preferred example, comprising:

(a) producing a video clip with a plurality of marks thereon;
(b) setting a mark pointer on one of the marks located on the video clip;
(c) receiving two acting signals to proceed the following step;
(d) calculating a time interval between the two acting signals; and
(e) moving the mark pointer towards the ending part of the video clip from a present position, wherein when the mark pointer reaches the next mark, it will stop, the corresponding video data are transferred to a video displaying device to display either fast forwardly or slowly or normally in such that the display will be performed exactly within the time interval.

The step (e) further comprises of relocating the mark pointer at a beginning part of the video clip when the mark pointer arrives at the ending part of the video clip, the method will then proceed the rest of steps, and producing an audio data and transferring it to an audio player for displaying when the mark pointer arrives at one of the marks. The acting signal producing unit is utilized a video camera to retrieve image signals of a moving body by recording movements of the moving body, and through analyzing, the retrieved image signals can be generated into acting signals.

Both the forgoing general description and the following detailed description are exemplary and explanatory only and are not restrictive of the invention, as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram demonstrating an interactive video displaying system in accordance with a preferred embodiment of the present invention;

FIG. 2 is a schematic diagram demonstrating an interactive video displaying method in accordance with a preferred embodiment of the present invention;

FIG. 3 is a schematic diagram demonstrating an interactive video displaying method in accordance with the second preferred embodiment of the present invention;

FIG. 4 is a schematic diagram demonstrating an interactive video displaying method in accordance with the third preferred embodiment of the present invention;

FIG. 5 is a schematic diagram demonstrating an interactive video displaying method in accordance with the fourth preferred embodiment of the present invention;

FIG. 6 is a schematic diagram demonstrating an interactive video displaying method in accordance with the fifth preferred embodiment of the present invention;

FIG. 7 is a schematic diagram demonstrating a method of an interactive video display system in accordance with a preferred embodiment of the present invention;

FIG. 8 is a schematic diagram demonstrating the method of an interactive video display system in accordance with another preferred embodiment of the present invention.

FIG. 9 is a schematic diagram demonstrating the method of an interactive video display system in accordance with another embodiment of the present invention.

FIG. 10 is a schematic diagram demonstrating the method of an interactive video display system in accordance with another embodiment of the present invention.

### DETAILED DESCRIPTION OF PREFERRED EMBODIMENTS

Now, preferred embodiments of the present invention will be described in detail with reference to the accompanying drawings. It should be noted, however, that the scope of the present invention is not limited by the illustrated embodiments.

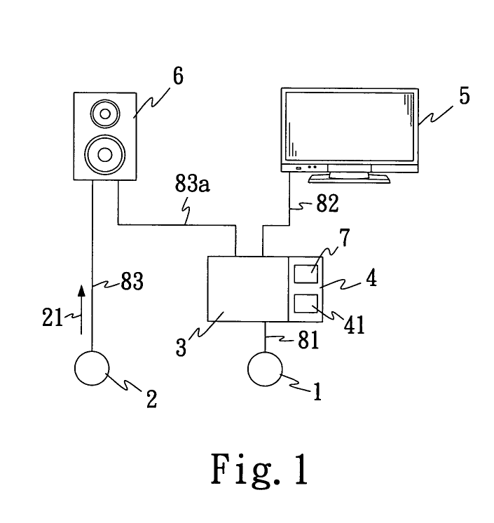

FIG. 1 is a diagram illustrating an interactive video displaying system according to a preferred embodiment of the present invention. The interactive video displaying system of the present invention can detect movements, verbal commands of a user or use a computer controller to control pre-determined data within a video clip 7 of a data storage device 4 so that the video clip 7 stored in the data storage device 4 can be retrieved and transferred to a video displaying device 5 for displaying. Simultaneously, the audio data 21 produced from the user, or the audio data 41 pre-recorded and stored in the data storage device 4, or the audio data 21 produced from the computer is transferred to an audio displaying device 6 to display. A plurality of marks are on the video clip 7, wherein two of the marks of the video clip 7 are arranged respectively for an introduction and a conclusion of the video clip 7. An acting signal producing unit 1 produces acting signals and transfers the acting signals to the control device 3 through transferring means 81, wherein the control device 3 retrieves video data from the video clip 7 stored in data storage device 4 and transfers partial video data according to the acting signals to the video displaying device 5 through the transferring means 82 for displaying. Meanwhile, the audio data producing unit 2 produces the audio data 21, and transfers it to the audio displaying device 6 for displaying through the transferring means 83. The functions of the audio data producing unit 2 can be achieved by combining the control device 3 and the data storage device 4 in such that the control device 3 retrieves audio data stored in the data storage device 4 and transfers it through the transferring means 83a to the audio displaying device 6 for displaying. Furthermore, the acting signal producing unit 1 can produce the acting signals via various methods, such as, utilizing a video camera to retrieve the image signals of a moving object, through analyzing, the retrieved image signals can be transferred to the acting signals

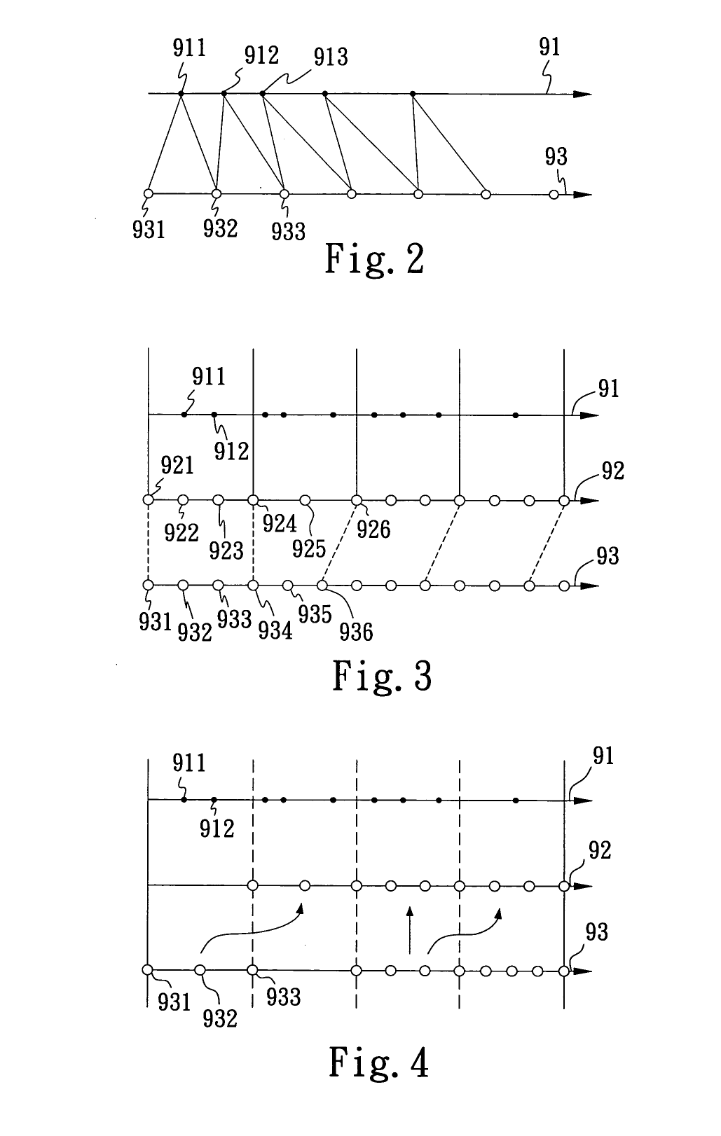

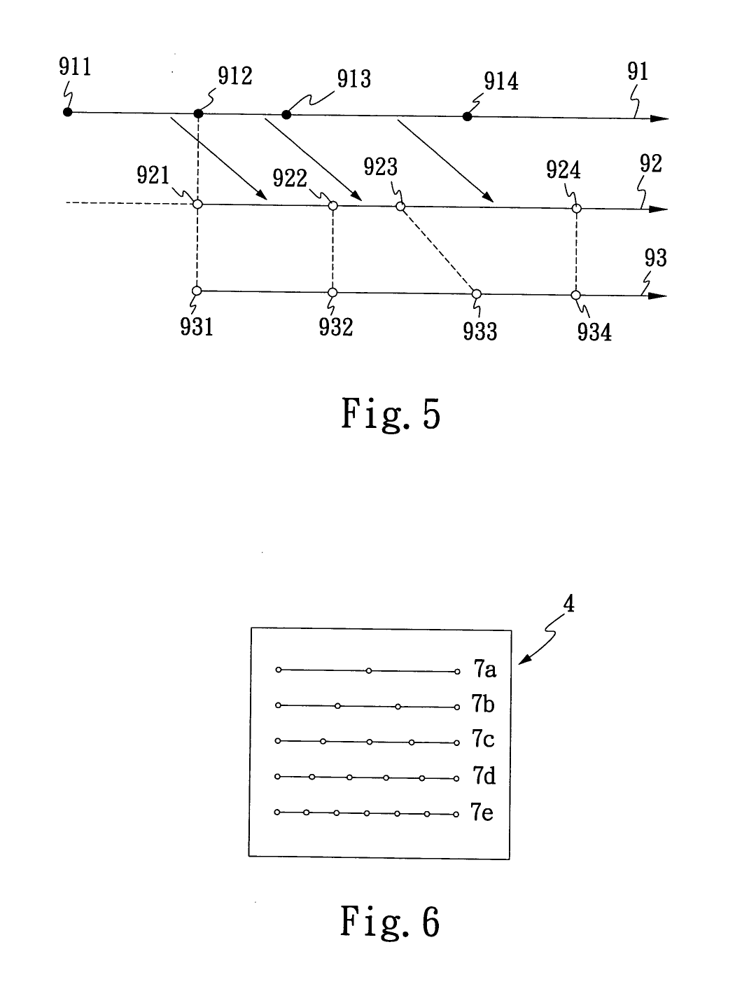

FIG. 2, FIG. 3, FIG. 4 and FIG. 5 are four different displaying methods according to the received acting signals respectively.

FIG. 1 and FIG. 2 are diagrams illustrating an interactive video displaying system and method respectively. An acting signal timeline 91 represents the acting signals which are produced by the acting signal producing unit 1 according to the proceeding time, a video clip timeline 93 represents the displaying of the video clip 7 in normal speed, and arrow signs are utilized to represent the proceeding time direction of the acting signal timeline 91 and the video clip timeline 93 after the system is started. The video clip 7 with a plurality of marks are produced during an interactive display process, wherein those marks are presented with hollow circles on the video clip timeline 93, further detail descriptions will be disclosed in the following preferred embodiments. An acting signal 911, an acting signal 912 and an acting signal 913 are presented on the acting signal timeline 91 according to the proceeding time direction. A mark 931, a mark 932 and a mark 933 are indicated on the video clip timeline 93 according to the proceeding time direction. When the display system start to operate in accordance with a preferred example, a mark pointer is set on one of the marks of the video clip 7 such that the mark 931 is indicated as a beginning part of the video clip 7. The acting signal 911 produced by the acting signal producing unit 1 is transmitted to the control device 3 through the transferring means 81, and once the control device 3 receives the acting signal 911 produced by the acting signal producing unit 1, the control device 3 will control the mark pointer by moving from the current position, such as the mark 931, toward an ending part of the video clip 7. Simultaneously, image data of the corresponding video clip 7 indicated by the mark pointer is transmitted to the video displaying device 5 through the transferring means 82. When the mark pointer moves to the following predetermined mark (can be through more than one mark) such as, the position of the mark 932, it will stop at the position of the mark 932, the control device 3 will simultaneously stop outputting, and wait for receiving the next instructional signal. Until the acting signal 912 is received by the control device 3, the display system will repeat its proceeding steps as mentioned above. If control device 3 receives the acting signal transmitted from the acting signal producing unit 1 while the mark pointer is still moving, then the control device 3 would instruct the mark pointer to jump to the next following acting mark and repeat the above-mentioned proceeding steps. But if the mark pointer arrives the ending part of the video clip 7, the mark pointer would be set on the beginning part of the video clip (which is the mark 931). The audio data producing unit 2 produces audio data 21 and transmits it to the audio displaying device 6 through the transferring means 83 when the mark pointer arrives each mark. The functions of the audio data producing unit 2 can be achieved by combining the control device 3 and the data storage device 4, whereby, the control device 3 can retrieve the audio data stored in the data storage device 4 and transfer it to the audio displaying device 6 through the transferring means 83a for displaying.

FIG. 1 and FIG. 3 are diagrams illustrating an interactive video displaying system and a method respectively, the ultimate difference between FIG. 2 and FIG. 3 is the displaying timeline 92 which represents the real displaying time of the video clip. First for all, a video clip 7 with a plurality of marks are produced, wherein those marks are presented with hollow circles on video clip timeline 93. The displaying timeline 92 indicates the display proceeding time operating from the displaying mark 921 to the displaying mark 926. When a segment of video clip timeline 93 is equal to a corresponding segment of the displaying timeline 92, it indicates that the video clip is displayed within a same timeframe, in other words, the displaying of the video clip is operated in normal speed. When a segment of the displaying timeline 92 is longer than the corresponding segment of the video clip timeline 93, it represents that it takes more time to display the video clip, thus, the displaying is performed in slower speed, vice versa, when a segment of the displaying timeline 92 is shorter than the corresponding segment of the video clip timeline 93, it indicates that less time is used to display the video clip, a faster displaying speed is operated in the displaying system, such as the function of fast forwarding.

Initially, a mark pointer is positioned on one of the marks of the video clip 7 and a counter is set and the value stored in the counter is set to be a predetermined quantity. then every predetermined time unit is retrieved according the orders of the displaying time periods, and the following steps have to be operated within every predetermined time unit, such as: calculating a second quantity from the stored value in the counter; shifting the mark pointer from a current position towards an ending position of the video clip; simultaneously, and arriving at a mark that is located right after passing through the second quantity of marks, retrieving the video data of the video clip 7 in respect of the mark pointer and transferring the video data to a displaying device in order to display the video data fast-forwardly or slowly or normally within the predetermined time unit; and, receiving a first quantity of acting signals and storing the data of first quantity into the counter.

Refer to FIG. 3, the time period between the acting signal timeline 91 and the displaying timeline 92 is divided into a plurality of time units, wherein four of the time units are selected for demonstrating the operations and functions of the interactive video displaying system in accordance with the preferred examples of the present invention.

The mark pointer starts from the location of the mark 931 that is the beginning part of the video clip. A second quantity can be calculated from the value stored inside the counter based on 1:1 ratio (or other ratios) according to one of preferred examples of the present invention, such as, when the value of the counter is 3, using the calculating ratio 1:1 between the second quantity to the value of the counter, the second quantity will be 3. However, it is intended that the descriptions and examples in the specification to be considered as exemplary only, the true scope and spirit of the invention do not limit the calculating ratio to just one type, other ratios also can be utilized to achieve the similar results.

From the above preferred example, if the calculated second quantity is 3, the mark pointer would move from the position of the mark 931 towards the ending of the video clip, resulting the mark pointer would pass through 3 intervals and arrive at a position of the mark 934. The video data of the video clips 7 in respect with the mark pointer is transferred to the video displaying device 5, the timeframe of this video section of the video clips is equal to the predetermined time unit, thus the audio data is displayed with the normal speed. The interactive video displaying system also receives two acting signals of the acting signal 911 and the acting signal 912 within the same time unit, and reset the value of the counter to be 2.

After the first time unit is ended, the above-mentioned proceeding steps will be repeated in the second time unit, wherein the mark pointer moves from the mark 934 towards the ending part of the video clip passing through two marks to reach the position of the mark 936. From the FIG. 3, the actual time required to display the video data of the video clip is less than the predetermined time unit, such as the second time unit. Therefore, in order to display the audio data of the video clip 7 concurring with the timeframe of the second time unit, slow speed of displaying is operated to display the video clip 7 in the second time unit. Once the mark pointer reaches the ending part of the video clip 7, the mark pointer will be relocated at the mark 931 which is positioned at the beginning part of the video clip 7.

During the displaying process, when the mark pointer reaches the mark, the audio data producing unit 2 produces audio 21 through the transmission path 83 to transmit audio data to the audio displaying device 6. The audio data producing unit 2 can be replaced with a combination of the control device 3 and the data storage device 4, wherein the control device 3 will select the prerecorded audio data inside the data storage device 4 and transmit the audio data through the transmission path 83a to the audio displaying device 6 for displaying.

FIG. 4 is a schematic diagram demonstrating an interactive video displaying method in accordance with a preferred embodiment of the present invention. A video clip with a plurality of video segments is produced, wherein every video segment comprises a plurality of marks corresponding with various exercising frequencies, and those video segments are divided in such that they all have the same display timeframe. A counter is set, and a predetermined time unit equaled to the displaying timeframe of those video segments is retrieved. During the predetermined time unit, the following proceeding steps are carried out: calculating a second quantity from the stored value within the counter; selecting the video segment with corresponding exercising frequency by using the second quantity; retrieving video data of such video segment and displaying it in a normal speed; receiving a first quantity of acting signals, and storing the data of first quantity in the counter.

Refer to FIG. 4, the acting signal timeline 91, the displaying signal timeline 92 and the video clip timeline 93 are equally divided into several time units, wherein four of time units are selected to demonstrate the operations of the interactive video displaying system in accordance with the preferred examples. The mark pointer is moved to the position of mark 931 which is the beginning part of the video clip 7, the second quantity is obtained by calculating from the stored value inside the counter according to 1:1 ratio (other ratios can be utilizable), and in such instant, the stored value of the counter is set to be zero.

In the first time unit, the second quantity is calculated from the stored value of the counter according to the ratio 1:1 to obtain a result of zero value, therefore, it indicates that there is no video segment with corresponding exercising frequency, as a result, such video data is not displayed. In the same time unit, the system receives two acting signals, the acting signal 911 and acting signal 912, and the value of the counter is then set to be 2. Once the first time unit is ended, the above-mentioned proceeding steps are repeated in the second time unit in such that the second quantity calculated from the stored value of the counter using the ratio 1:1 would be 2.

The second quantity 2 is then utilized to search the video segments with corresponding exercising frequencies. According to the preferred example of the present invention, the second quantity 2 would determine the video data between the mark 931 and the mark 933 to be selected and retrieved. The video data is then displayed in the normal speed within the second time unit. Simultaneously, the system would receive three acting signals, and the above-illustrated proceeding steps would be repeated to continue the process. During the displaying process, the mark pointer moves to a particular mark in such that the audio data producing unit 2 produces audio data 21 and transmits it through the transmission path 83 to the audio displaying device 6 to display. The audio data producing unit 2 can be replaced by the combination of the control device 3 and the data storage device 4, wherein the control device 3 selects the audio data stored inside the data storage device 4, and transmits it via the transmission path 83a to the audio displaying device 6 for displaying.

Refer to FIGS. 1 & 5, wherein FIG. 5 is a schematic diagram demonstrating an interactive video displaying method in accordance with a preferred embodiment of the present invention. A video clip with a plurality of marks is generated, and a mark pointer is set at one of the marks of the video clip, wherein the mark pointer is positioned at the mark 931 which is located on the beginning part of the video clip. The system receives two acting signals, which are the acting signal 911 and the acting signal 912, and a time interval between these two acting signals are calculated The mark pointer is moved from the current position towards the ending part of the video clip until the mark pointer arrives the next mark, which is the mark 932, then it stops. The video data of the corresponding video clip is displayed either through the function of fast forward, slow motion or normal speed in respect to the position of the mark pointer in such that the display would be operated within the time interval. In such incident, the time interval between the acting signal 911 and the acting signal 912 is equaled to the video time interval between the mark 931 and the mark 932, so that display can be performed in the normal speed. Similarly, the rest of the vide clip are displayed according the above-mentioned proceeding steps. When the acting signal 913 is received by the system, the time interval between the acting signal 912 and the acting signal 913 is calculated, and the video data between the mark 932 and the mark 933 is displayed within a displaying timeline 93. From the drawings, it is clear that the displaying time interval between the displaying mark 922 and the displaying mark 923 of the displaying timeline 92 is actually shorter than the video time interval between the mark 932 and the mark 933. Thus, the video data is fast-forwardly displayed. When the acting signal 914 is produced, the system calculates the time interval between the acting signal 913 and the acting signal 914, and the video data between the mark 933 and the mark 934 is displayed within the displaying timeline 93. From the drawings, it is clear that the displaying time interval between the displaying mark 923 and the displaying mark 924 of the displaying timeline 92 is longer than the displaying video time interval between the mark 933 and the mark 934. Thus, the video is slowly displayed. If the mark pointer reaches the ending part of the video clip 7, the mark pointer would be relocated at the mark 931, which is located at the beginning part of the video clip 7. During the displaying process, the audio data 21 is produced by the audio data producing unit 2 when the mark pointer reaches the mark, and it is transmitted via the transmission path 83 to the audio displaying device 6 for displaying. As a matter of fact, the audio data producing unit 2 can be replaced by the combination of the control device 3 and the data storage device 4, wherein the control device 3 retrieves audio data stored in the data storage device 4, and transfers it to the audio displaying device 6 through the transmission path 83a for displaying the audio.

FIG. 6 is a schematic diagram demonstrating an interactive video displaying method in accordance with another preferred embodiment of the present invention. Refer to FIGS. 1, 2, 3 and 6, the method disclosed in FIG. 6 is represented by combining the methods disclosed in FIG. 2 and FIG. 3. There are five different video clips with corresponding exercising frequencies stored in the data storage device 4, wherein a mark is set at a turning point of a reversed exercising direction of every video clip with different frequencies, such as a video clip 7a, a video clip 7b, a video clip 7c, a video clip 7d and a video clip 7e, are all represent the sequential order of the exercising frequencies from slow to fast motion of the vide clips. In other words, those video clips 7a-7e indicate that the density of the marks on the video clips is from the sparse to dense markings.

During the operations of the interactive video displaying system, every time the system passes through one time unit, the acting signal(s) is received and calculated to obtain acting signal producing frequency that is generated from the acting signal(s) of every time unit in such that a corresponding video clip is selected according to the acting signal producing frequency. When the acting signal producing frequency is fallen in between two exercising frequencies of video clips, a video clip with higher exercising frequency is selected, and its video data is displayed through the method disclosed in FIG. 2. If the acting signal producing frequency is higher than the video clip with the highest exercising frequency, then the video clip of the highest exercising frequency is displayed fast-forwardly via the method disclosed in FIG. 3. When the acting signal producing frequency is lower than the video clip with the lowest exercising frequency, the video clip of the lowest exercising frequency is displayed slowly through the method taught in FIG. 3.

When the mark pointer arrives the ending part of the video clip, the mark pointer will be relocated at a mark that is at the beginning part of the video clip. During the displaying process, the audio data 21 is produced by the audio data producing unit 2 when the mark pointer reaches the mark, and the audio data is transmitted via the transmission path 83 to the audio displaying device 6 for displaying. The audio data producing unit 2 can be replaced by the combination of the control device 3 and the data storage device 4, wherein the control device 3 retrieves audio data stored in the data storage device 4, and transfers it to the audio displaying device 6 through the transmission path 83a for displaying the audio.

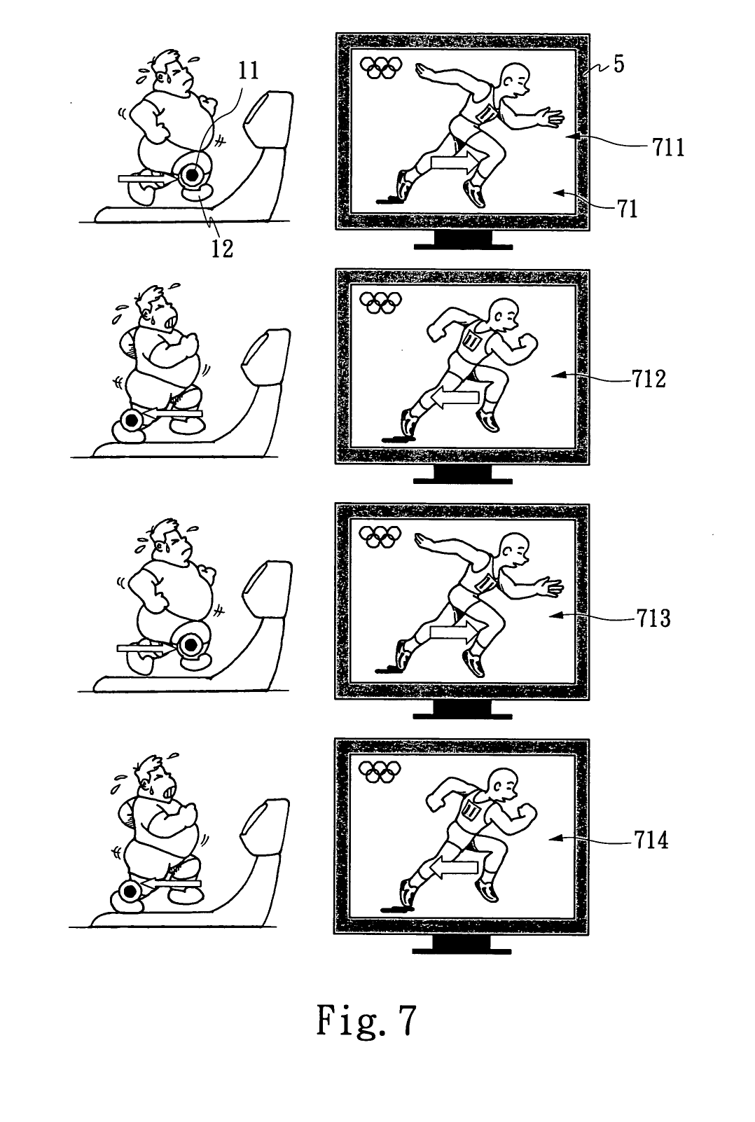

FIG. 7 is a schematic diagram demonstrating a method of an interactive video display system in accordance with another preferred embodiment of the present invention. Refer to FIGS. 1, 3, 4 and 7, this preferred embodiment illustrates a user simulating an Olympic runner running style, and this embodiment is operated in accordance with the method disclosed in FIG. 3 by utilizing the acting signals to control the video clips. The method comprises: processing a section of the video clip comprising the Olympic athlete's running footage 71; setting a mark at the beginning part of the video clip, and setting another mark at a point to indicate that either one of the feet of the Olympic athlete touches the ground. Four marks are selected at the beginning part of the video clip to demonstrate the method sequentially from the mark 711 to 714 of the video clip. The video clip 71 of Olympic athlete running together with the audio of the foot touching the ground is prerecorded in the data storage device 4.

The audio producing unit 2 is accomplished by the integration of the control device 3 and the data storage device 4. The user equips a detecting device 11 onto his right foot 12 (or the left foot), and the detecting unit 11 detects all the linear movement of the right foot, wherein a plurality of acting signals received by the system in the same time unit are recorded in the system to decide the number of the marks to be passed in the next time unit, and determine how to display the corresponding video images either through fast forward, slow motion or normal speed. At the same time, the prerecorded audio effect of the runner's feet touching the ground in the video clip 71 is delivered.

The method illustrated in FIG. 4 discloses how acting signal controlled the video clip. Part of the Olympic athlete running video clip 71 is pre-processed so that a plurality of video segments are stored in the video clip 71, wherein different video segments are corresponding to different moving frequency of the runner's feet. A mark is set on each point of the video clip to indicate every time when the runner's foot touches the ground in each segment so that from the density of the marks, such as the section with dense marks can represent the part of the video clip comprising the fast moving frequency of the athlete's body movement, vice versa, where the section with spare marks indicates that the slow moving frequency of the athlete's body movement in the video clip. The user equips the detecting device 11 on his right foot 12 (or the left foot), and the detecting unit 11 detects the movement of the right foot moving back and forth to generate the acting signals. The system records the number of the acting signals within the same time unit. The system selects the video segments with the number of marks that are closest to the recorded number of the acting signals, and displays it in normal speed within the next time unit. Simultaneously, the prerecorded soundtrack of the Olympic athlete's feet touching the ground when he is running is displayed.

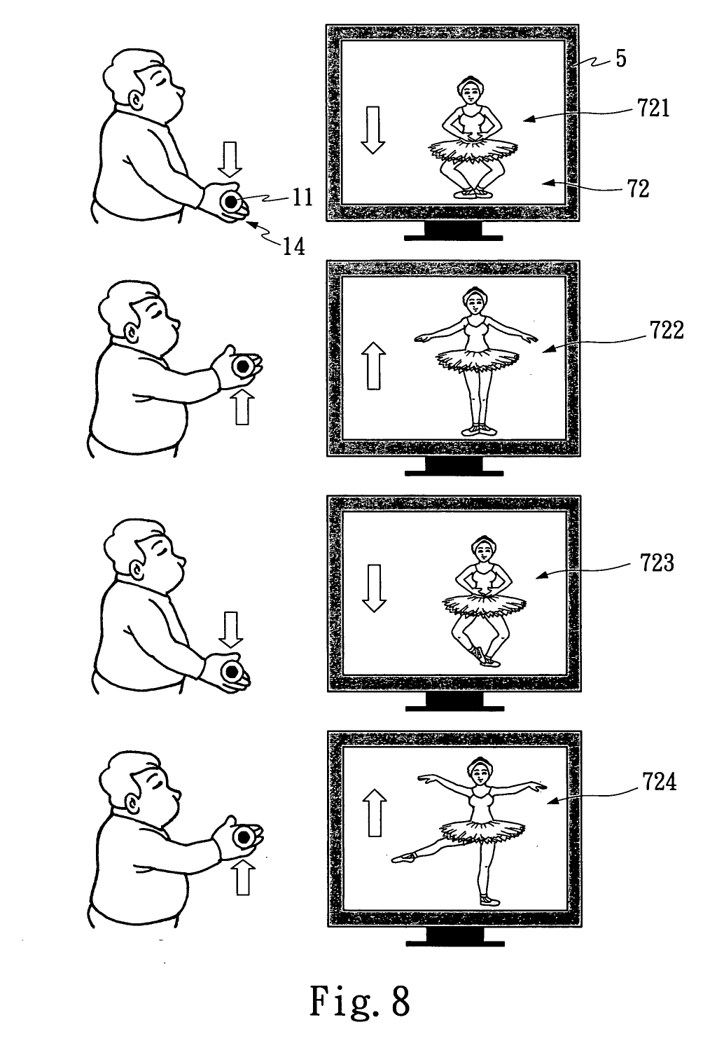

FIG. 8 is a schematic diagram demonstrating the method of an interactive video display system in accordance with another preferred embodiment of the present invention. Refer to FIGS. 1,2,3, 6 and 8, this embodiment illustrates the method of a user directly controlling over the body movement of an actor in the video clip, such as moving upward or downward. The user equips a detecting unit 11 onto his right hand 14 (or the left hand), wherein when the right hand 14 of the user moves up or down resulting changes in direction of the perpendicular movement, the detecting unit 11 detects the changes and produces acting signals to control the video display of the video clip in the video displaying device 5. Several video clips comprising ballet dancer dancing images are prerecorded and stored in the data storage device 4, and a video clip 7a to a video clip 7e are represented and corresponding the dancing frequencies of the ballet dancer from the slow frequency to the fast frequency. A mark is set at the video clip every time when the ballet dancer stands up and bents down in the video. When the system starts, the system calculates the number of the acting signals received every time when the system passes through a time unit in such that the frequencies produced by the acting signals can be retrieved in each time unit. The corresponding video clips can be chosen in accordance with the frequencies produced from the acting signals. If the frequency produced from the acting signal falls in an interval between the exercising frequencies of two video clips, the video clip with the higher exercising frequency is selected. The video data of the video clip is then displayed in accordance with the method disclosed in FIG. 2. When the frequency produced from the acting signal is higher than every exercising frequency of the video clip, the video clip with the highest exercising frequency is selected and displayed fast forwardly in accordance with the method disclosed in FIG. 3. When the frequency produced from the acting signal is lower than every exercising frequency of the video clip, the video clip with the lowest exercising frequency is selected and displayed slowly in accordance with the method disclosed in FIG. 3. The user then can utilize the up-and-down movements of his right hand to control the prerecorded movements of the ballet dancer such that the display is performed smoothly with corresponding audio effect.

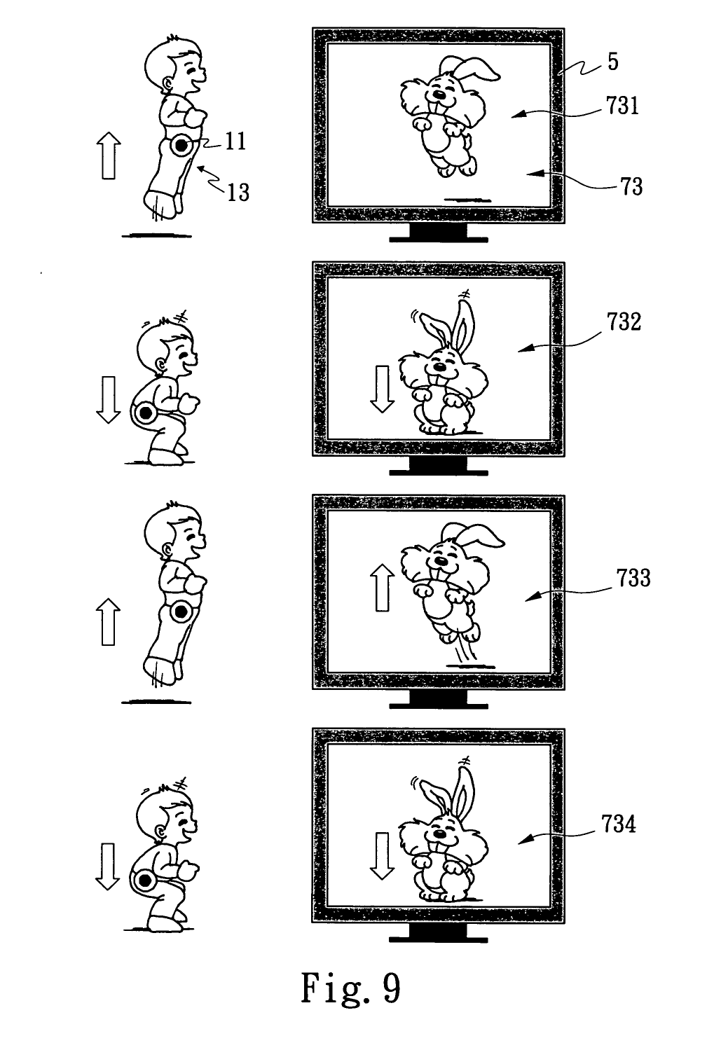

FIG. 9 is a schematic diagram demonstrating the method of an interactive video display system in accordance with another preferred embodiment of the present invention. This embodiment shows how a user can control the movements of a moving object, such as jumping, in the video clip. First for all, the detecting unit 11 is positioned on a user's waist and the jumping movement of the user can result the exercising direction changing along a perpendicular direction of the jumping motion which is detected by the detecting unit 11 to produce acting signals in order to control the display of the cartoon in the video displaying device 5.

The method disclosed in FIG. 5 demonstrates the utilization of the acting signals to control the movements in the video clips. From the figure, images data of a cartoon figure of a rabbit jumping is restored in the system, wherein the highest jumping point and the lowest dropping point of the rabbit are determined, and marks are set at those points in the video clip 73. Four marks are selected at the beginning part of the video clip 73 to illustrate the operations of the method, video clip mark 731 to video clip mark 734 are set and corresponding to the mark 931 to the mark 934 on the timeline 93 of the prerecorded video clip in FIG. 5. Those audio data of touching the ground are prerecorded simultaneously in the data storage device 4. At the beginning of the operation, the child in FIG. 9 starts to jump, the system detects the movement and produces an acting signal 911. When the child jumps to the highest point and starts to drop, indicating the reversed exercising direction, an acting signal 912 is produced. The system then calculates the time interval between the acting signal 911 and the acting signal 912 so that the time required to display the video data between the mark 931 to mark 932 on the timeline 93 is determined. As a matter of fact, the time also represents the time required to display the video data between the video clip mark 731 to video clip mark 732, in other words, it indicates that the carton rabbit in the video clip 73 drops from the highest point to the lowest point. From the above-mentioned steps, the whole video clip can be displayed accordingly form the video clip mark 732 to the video clip mark 734 incorporated with the prerecorded sound effect of stamping. Therefore, the video clip 73 can displays the simulating image of the cartoon rabbit jumping preciously as the child's movement.

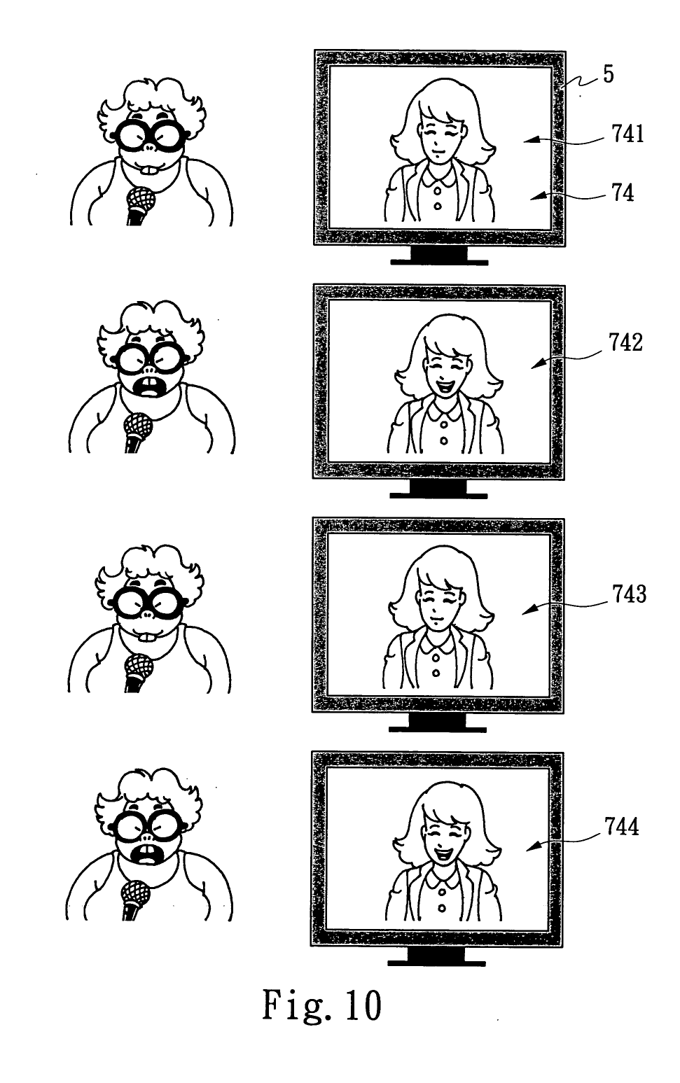

FIG. 10 is a schematic diagram demonstrating the method of an interactive video display system in accordance with another preferred embodiment of the present invention. Refer to FIGS. 1, 2 and 10, this preferred embodiment is about how a user in a close distance can control the speaking image of an actor in the video displaying device 5 that is located in remote distance. The system of the present invention can provide a display of the speaking image of a serviceman on the screen which is controlled by the user's sound and speech. The main difference of this embodiment with the above-mentioned preferred embodiments is that the audio data producing unit 2 is no longer replaced by the integration of the functions of the control device 3 and the data storage device 4. The data of the audio data producing unit 2 is generated form the user's sound, and is transmitted through the transmission path 83 to the audio displaying device 6 for voice displaying. When the user pronounces sound, the system detects the sound signal and produces an acting signal to transmit the sound signal to the control device 3 through the transmission path 81 in order to control the display of the spokesman of the video clip 74 stored in the data storage device 4. The data of the spokesman of the video clip 74 is transmitted to the video displaying device 5 via the transmission path 82 for displaying. The sound produced by the user will result sound signal 21 to be produced in the system, and it is transmitted through the transmission path 83 to the audio displaying device 6 for displaying. In this preferred embodiment, in order to avoid the huge data storage space that could occupy too much bandwidth for transmitting video data resulting the delayed effect on the display of the video. The transmission path 81 and the transmission path 83 are utilized the internet to transmit the data. The path 82 uses wire transmission in such that the data, such as the sound signal 21 and the acting signal, are transmitted through the internet, but the image signal is prevented to be transmitted through the internet in order to ensure a clear display screen. But the control device 3 and the data storage device 4 can be installed at the near end of the user for the purpose of convenience. The transmission path 83 and the transmission path 82 both using internet transmission, and the transmission path 81 comprises wire network in such that only a video displaying device 5, audio displaying device 6 and the connection to the internet are required to be installed at a far end for transmission.

The near end of the system close to the user can be connected to a computer so that the computer can simultaneously transmit an acting signal and the sound signal 21 to the far end in order to control the speech effect of the actor or the spokesman in the video clip at the far end of the system. The computer can also control the display of speaking and singing sound track. Every sound signal results an acting signal and those signals are transmitted to the far end at the same time. The computer can read a word text file and produce sound track according to the each word utilizing its specific software. When the system read each word of the text file, the computer can generate every pronunciation to produce a sound signal and an acting signal wherein both signals are transmitted to the far end. The computer can also receive the image signals from the moving object transmitted from the video camera, through processing and analysis, each movement of the moving object can produce an acting signal.

The present invention provides an interactive displaying system and method that can utilize the user's body movements and sound or the computer-generated signal to control the display of the video clips incorporated with the audio effect to increase the reality of the image display.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An interactive video displaying system, comprising:
a video displaying device for displaying video data;
a data storage device having at least one video clip comprising a plurality of marks, wherein two of the marks are arranged respectively at a beginning part and an ending part of the video clip;
an acting signal producing unit for producing and transmitting an acting signal; and
a control device for setting a mark pointer on one of the marks of the video clip according to the acting signal produced by the acting signal producing unit, wherein a position of the mark pointer on the mark of the video clip is utilized as a display starting point to display the video data of the video clip in respect to the mark pointer.

2. The interactive video displaying system according to claim 1, wherein the system further comprises an audio displaying device and an audio data producing unit, the audio data producing unit produces an audio signal and transmits it to the audio player for displaying.

3. The interactive video displaying system according to claim 2, wherein at least one audio signal is prerecorded and stored in the data storage device, and the control device retrieves at least one audio signal that is prerecorded and stored in the data storage device in order to replace the audio data producing unit.

4. The interactive video displaying system according to claim 2, wherein the audio data producing unit can be a user.

5. The interactive video displaying system according to claim 2, wherein the audio data producing unit is an external electric device.

6. The interactive video displaying system according to claim 2, wherein the acting signal producing unit further comprises a detecting device for detecting any variation of a movement direction of a moving object, when the detecting device detects the movement of the moving object, a starting point of movement and a turning point of a changing movement direction of the moving object, an acting signal is produced.

7. The interactive video displaying system according to claim 6, wherein the detecting device further comprises a functional key, when the functional key is triggered, the mark pointer will be moved to a next mark of the video clip immediately.

8. The interactive video displaying system according to claim 1, wherein the acting signal producing unit is an external electric device which produces the acting signal according to a predetermined program.

9. The interactive video displaying system according to claim 1, wherein the acting signal producing unit utilizes a microphone to receive an audio signal and transfers this audio signal into an acting signal.

10. The interactive video displaying system according to claim 1, wherein the acting signal producing unit is an external electric device displays an audio signal, and transfers the audio signal into an acting signal.

11. The interactive video displaying system according to claim 1, wherein the video displaying device is a computer monitor.

12. The interactive video displaying system according to claim 1, wherein the video displaying device is a television or a portable electric device with a monitor.

13. The interactive video displaying system according to claim 1, wherein a manual method is utilized to preset every mark on the video clip via an image processing apparatus, and those data are stored in the data storage device.

14. The interactive video displaying system according to claim 1, wherein a detecting device is provided in the system to record a moving object in such that the video clip comprises a plurality of marks, and data is stored in the data storage device.

15. The interactive video displaying system according to claim 1, wherein the acting signal producing unit transmits the acting signal to the control device via a wire connection, or a wireless connection or an internet transmission.

16. The interactive video displaying system according to claim 1, wherein the control device utilizes a transmission method, either a wire connection, a wireless connection or an internet transmission, for transferring the video data from the data storage device to the video displaying device.

17. The interactive video displaying system according to claim 2, wherein the audio data producing unit transfers the audio data to the audio displaying device utilizing a method of a wire connection, or a wireless connection or an internet transmission.

18. An interactive video displaying method, comprising:
(a) producing a video clip with a plurality of marks;
(b) setting a mark pointer on one of the marks located on the video clip;
(c) receiving an acting signal in order to perform the next step;
(d) moving the mark pointer from a current position towards an ending part of the video clip, and transferring corresponding video data of the video clip to a video displaying device in respect to the position of the mark pointer during the moving process. When the mark pointer is moved through a first quantity of marks or to the ending part of the video clip, then the mark pointer will be stopped, and the step (c) will be repeated, wherein when the acting signal is received during the proceeding of the step (d), the mark pointer will be moved to the next mark and the step (d) will be repeated.

19. The interactive video displaying method according to claim 18, the method further comprising:
producing an audio data when the mark pointer reaches one of the marks, and
transferring the audio data to an audio player for displaying.

20. The interactive video displaying method according to claim 18, wherein the first quantity is a positive integer.

21. The interactive video displaying method according to claim 18, the method further comprising: relocating the mark pointer at a beginning part of the video clip when the mark pointer arrives the ending part of the video clip, and the method continues to proceed.

22. The interactive video displaying method according to claim 19, wherein the method comprises of equipping a detecting unit onto a body or arms or legs of a user, when the user starts to move, the detecting unit detects the movement of the user and the changing points of indicating changes in movement direction in order to produce acing signals, and when the mark pointer arrives one of the marks, the audio data stored in the data storage device will be displayed.

23. An interactive video displaying method, comprising:
(a) producing a video clip with a plurality of marks thereon;
(b) locating a mark pointer on one of the marks positioned on the video clip, setting a counter, and repeating a following step;
(c) calculating a second quantity according to the value stored in the counter, retrieving a predetermined time unit, and proceeding the following steps within the predetermined time unit:
(c1) moving the mark pointer towards an ending part of the video clip from a present position, and arriving at a mark that is located right after passing through the second quantity of marks, wherein the video data of the video clip corresponding to the mark pointer is transmitted fast-forwardly, or slowly or normally to a video displaying device for displaying in such that the display can be performed exactly within the predetermined time unit; and
(c2) receiving a first quantity of acting signals, and saving the data of such first quantity in the counter.

24. The interactive video displaying method according to claim 23, wherein the step (c) further comprises of producing an audio data and transferring it to an audio player for displaying when the mark pointer arrives one of the marks.

25. The interactive video displaying method according to claim 23, wherein the step (b) further comprises of setting a zero value in the counter.

26. The interactive video displaying method according to claim 23, wherein the step (c) further comprises of relocating the mark pointer at a beginning part of the video clip when the mark pointer reaches the ending part of the video clip and the method continues to proceed.

27. An interactive video displaying method, comprises:
(a) producing a video clip with a plurality of video segments, wherein each video segment comprises a plurality of marks and is corresponding to different moving frequency, and the video segments have the same video time; (b) setting a counter and executing the next step repeatedly; (c) calculating a second quantity according to the data stored in the counter; selecting the video segment with corresponding moving frequency in accordance with the second quantity; retrieving a predetermined unit time that is equal to the video time of each video segment, and proceeding the following steps within the same predetermined time unit:
(c1) retrieving the video data of the video segment and displaying it with normal speed; and
(c2) receiving a first quantity of acting signals, and saving the data of such first quantity in the counter.

28. The interactive video displaying method according to claim 27, wherein the step (c) further comprises of producing an audio data and transferring it to an audio player for displaying when the mark pointer arrives one of the marks.

29. The interactive video displaying method according to claim 27, wherein the step (b) further comprises of setting a zero value in the counter.

30. An interactive video displaying method, comprising:
(a) producing a video clip with a plurality of marks thereon;
(b) setting a mark pointer on one of the marks located on the video clip;
(c) receiving two acting signals to proceed the following step;
(d) calculating a time interval between the two acting signals; and
(e) moving the mark pointer towards an ending part of the video clip from a present position, wherein when the mark pointer reaches the next mark, it will stop, corresponding video data are transferred to a video displaying device to display either fast forwardly or slowly or normally in such that the display will be performed exactly within the time interval.

31. The interactive video displaying method according to claim 30, wherein the step (e) further comprises of relocating the mark pointer at a beginning part of the video clip when the mark pointer arrives at the ending part of the video clip, the method will then proceed the rest of steps.

32. The interactive video displaying method according to claim 30, wherein the step (e) further comprises of producing an audio data and transferring it to an audio player for displaying when the mark pointer arrives at one of the marks.

33. The interactive video displaying method according to claim 1, wherein the acting signal producing unit is utilized a video camera to retrieve image signals of a moving body by recording movements of the moving body, and through analyzing, the retrieved image signals can be generated into acting signals.
